(19) United States
(12) Patent Application Publication
(10) Pub. No.: US 2026/0095411 A1
(43) Pub. Date: Apr. 2, 2026

(54) MULTI-ORBIT AIR TO GROUND NETWORK ARCHITECTURE DESIGN

(71) Applicant: Panasonic Avionics Corporation, Irvine, CA (US)

(72) Inventors: Lai Sheng MIAO, San Diego, CA (US); Han MA, Irvine, CA (US); Jayme SNYDER, Ontario (CA)

(21) Appl. No.: 18/905,068

(22) Filed: Oct. 2, 2024

(51) Int. Cl. H04L 47/22; H04W 4/24; H04W 4/42

(52) U.S. Cl. CPC H04L 47/22; H04W 4/24; H04W 4/42

(57) ABSTRACT

A method for managing network traffic flow for a commercial passenger vehicle is provided. The method comprises: receiving, by a server comprising at least one processor, a request for a network session from a passenger device operating in a communication network onboard a commercial passenger vehicle; obtaining, from a payload of a predesignated packet in the network session, metadata that contains network traffic information associated with the communication network; correlating an identifier for the passenger device to a traffic flow in the network session, wherein the identifier is based on the metadata; and applying, based on the network traffic information, a traffic shaping policy to the passenger device corresponding to the identifier, wherein the traffic shaping policy controls routing of traffic flow of the passenger device through the communication network.

### TECHNICAL FIELD

This document is generally related to systems, methods, and apparatus to improve passenger experiences for passengers in commercial passenger vehicles such as airplanes, passenger trains, buses, cruise ships, and other forms of transportation.

### BACKGROUND

In the commercial travel industry, there exists a need to provide network connectivity to personal electronic devices (PEDs) that passengers carry on board, as well as media play devices provided in commercial passenger vehicles. Techniques to manage network traffic can provide passengers in commercial passenger vehicles a positive travel experience.

### SUMMARY

This patent document describes, among other things, various implementations for managing network traffic flow for commercial passenger vehicles.

In one aspect, a method for managing network traffic flow for a commercial passenger vehicle is provided. The method comprises: receiving, by a server comprising at least one processor, a request for a network session from a passenger device operating in a communication network onboard a commercial passenger vehicle; obtaining, from a payload of a predesignated packet in the network session, metadata that contains network traffic information associated with the communication network; correlating an identifier for the passenger device to a traffic flow in the network session, wherein the identifier is based on the metadata; and applying, based on the network traffic information, a traffic shaping policy to the passenger device corresponding to the identifier, wherein the traffic shaping policy controls routing of traffic flow of the passenger device through the communication network.

In another aspect, a system for managing network traffic flow for a commercial passenger vehicle is provided. The system comprises: a communication network, onboard the commercial passenger vehicle, comprising a plurality of network devices including passenger devices that are associated with respective passengers onboard the commercial passenger vehicle; and a processor in communication with the communication network and operable to control network connections of the network devices to one or more satellites or terrestrial communication stations; and wherein the processor is configured to: receive, by a server comprising at least one processor, a request for a network session from at least one of the passenger devices operating in the communication network; obtain, from a payload of a predesignated packet in the network session, metadata that contains network traffic information associated with the communication network; correlate an identifier for the at least one of the passenger devices to a traffic flow in the network session, wherein the identifier is based on the metadata; and apply, based on the network traffic information, a traffic shaping policy to the at least one of the passenger devices corresponding to the identifier, wherein the traffic shaping policy controls routing of traffic flow of the at least one of the passenger devices through the communication network.

In another aspect, a computer readable medium is provided. The computer readable medium stores instructions, upon execution by a processor, causing the processor to implement a method as suggested in this patent document.

The above and other aspects and their implementations are described in greater detail in the drawings, the description, and the claims.

### BRIEF DESCRIPTION OF THE DRAWINGS

FIG. 1 shows an example of an in-flight entertainment (IFE) system installed in an airplane based on some implementations of the disclosed technology.

FIG. 2 shows an example of a configuration including an overlay network system based on some implementations of the disclosed technology.

FIG. 3 shows an example of an overlay network system in communication with a commercial passenger vehicle based on some implementations of the disclosed technology.

FIG. 4 shows an example configuration of an overlay network system based on some implementations of the disclosed technology.

FIG. 5 shows an example of packet analysis in an overlay network system based on some implementations of the disclosed technology.

FIG. 6 shows an overlay network platform in communication with a commercial passenger vehicle based on some implementations of the disclosed technology.

FIG. 7 shows an example of a block diagram of an overlay network system based on some implementations of the disclosed technology.

FIG. 8 shows a block diagram of an example method implemented in an overlay network system based on some implementations of the disclosed technology

### DETAILED DESCRIPTION

In-flight connectivity services are commonly provided to aircraft via network service providers or satellite connectivity technologies such as Low Earth Orbit (LEO) or Geostationary Earth (GEO) satellite networks. In order to provide seamless and uninterrupted network service to passenger devices, airlines commonly deploy more than one network connectivity path which can help to manage traffic load distribution on the network. For example, in the event that one network connectivity path fails or becomes unavailable, traffic can automatically be rerouted to other available network connectivity paths. At the same time, airlines have a business need to implement per subscriber traffic shaping policies on the network, particularly when expensive network paths such as GEO satellite networks, LEO satellite networks, or cellular networks are used for connectivity. Thus, there exists a need for network traffic shaping tools which are aware not only of per subscriber traffic information but also the underlay network path type (e.g., LEO satellite, GEO satellite, cellular) and real-time underlay network path usage.

Existing traffic shaping technologies typically rely on identifying subscribers from traffic analysis, most commonly by tracking a source IP address associated with subscriber traffic. For example, overlay system technology (e.g., SD-WAN) is widely used by airlines for traffic management over multiple networks. However, when using SD-WAN technology, a network packet that has been shared between two overlay systems no longer contains the source and destination IP addresses of the original traffic and instead includes the IP address of the SD-WAN devices. In this scenario, the source and destination IP addresses associated with the original traffic becomes lost.

In recognition of the issues above, network traffic shaping techniques based on per subscriber information and underlay network path usage status are highly desired.

Various implementations of the disclosed technology provide network traffic shaping techniques for commercial passenger vehicles. The technical solutions described in the present document can be embodied in implementations to improve passenger experiences, among other features, by providing improved techniques for managing network traffic for commercial passenger vehicles. With various examples of the disclosed technology, it is possible to shape network traffic for a commercial passenger vehicle in a hybrid network system including multiple satellite networks and a cellular network to enhance the reliability and efficiency of passenger interactions with the network system.

Various implementations will be discussed in detail with reference to the figures below. In the description, an airplane is described as an example of the passenger vehicle, but the implementations of the disclosed technology can be applicable to other passenger vehicles such as buses, trains, ships, and other types of commercial passenger vehicles.

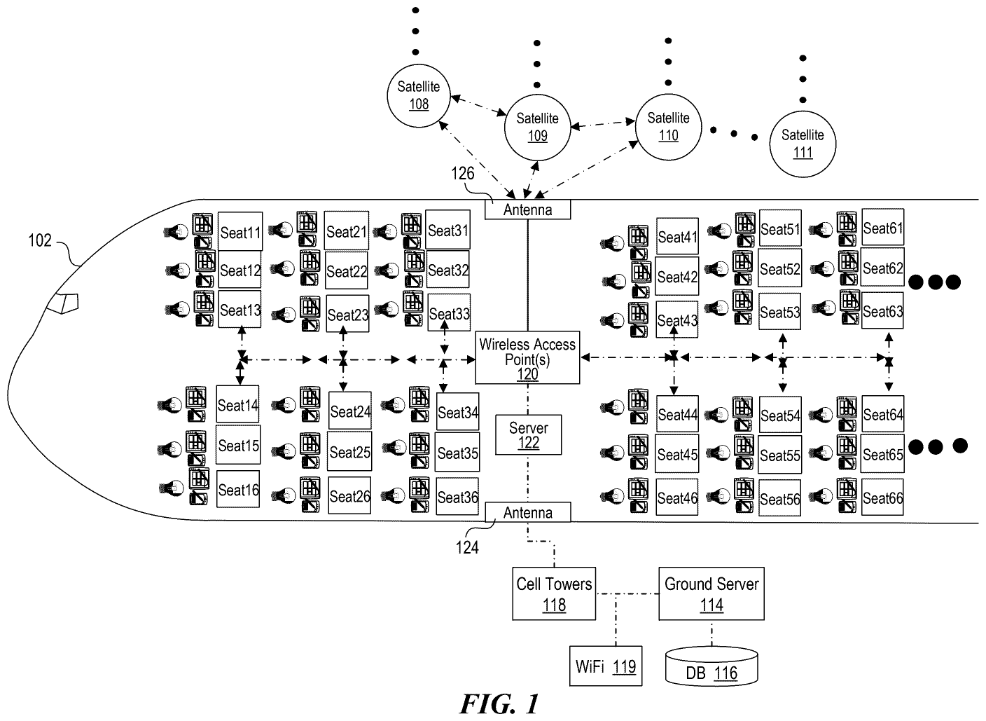

FIG. 1 shows an example of an in-flight entertainment (IFE) system for passengers in a commercial passenger vehicle such as an airplane. The example diagram of the in-flight system as shown in FIG. 1 is provided to explain how wireless connections are supported in the airplane 102. The components shown as a single element in FIG. 1, e.g., the server 122, the database 116, the wireless access point 120, etc. can be configured in multiple elements. For example, the in-flight service system can include multiple wireless access points to facilitate or support providing of wireless coverages for the passengers.

The IFE system provides various entertainment and connectivity services to passengers on board. Referring to FIG. 1, the IFE system includes a server 122, antenna 126, and antenna 124. The passengers carry their own devices, which include the PEDs (illustrated by the light bulb icon in FIG. 1) and other wireless electronic devices. The PEDs may refer to any electronic computing device that includes one or more processors or circuitries for implementing the functions related to data storage, video and audio streaming, wired communications, wireless communications, etc. The examples of the PEDs include cellular phones, smart phones, tablet computers, laptop computers, and other portable computing devices. In the implementations of the disclosed technology, the PEDs may have the capability to execute application software programs (“apps”) to perform various functions.

In FIG. 1, the airplane 102 is depicted to include multiple passenger seats, Seat 11 to Seat 66. The example diagram as shown in FIG. 1 shows the economy seats only but different types of passenger seats (e.g., premium economy class, premium class, first class, etc.) can be further provided in the airplane 102. The media playback devices (illustrated by screen icon) are provided at each passenger seat and configured with capabilities for video and audio streaming, Internet communications, and other capabilities. In some implementations, the media playback devices are provided at each passenger seat, such as located at each of the seatbacks of the passenger seats, and/or on cabin walls and/or deployable from an armrest for seats located at a bulkhead (i.e., in the first row of a section). The media playback devices have displays providing interfaces to each passenger through which each passenger enters their selections on the entertainment option, for example, a selection to watch a video program, a selection of a particular video program to watch, etc. The media playback devices can also allow each passenger to enter the selections of wireless network option, emergency requests, etc. To facilitate communications with the passengers, various graphic user interface (GUI) functions can be suggested and displayed on the media playback devices.

In some implementations, the media playback devices, the server 122, and the PEDs may be in communication through wired connections or wireless connections. In some implementations, the communication among the server 122, the media playback devices, and the PEDs are achieved through the antenna 124 to and from the ground-based cell towers 118 by, for example, a provision of network plugs at the seat for plugging PEDs to a wired onboard local area network. In some other implementations, the communications among the server 122, the media playback devices, and the PEDs are achieved through the antenna 126 to and from satellites 108, 109, 110, 111 in an orbit (e.g., via a cellular network utilizing one or more onboard base station(s), Wi-Fi utilizing the wireless access point 120, and/or Bluetooth). For example, the wireless network utilizing the wireless module of the media playback devices, and/or the wireless access point 120 can be formed among the server 122, the media playback devices, and the PEDs and allow the communication therebetween.

The server 122 is communicably coupled with media playback devices and the PEDs and configured to perform various operations including processing requests/inputs from passengers and providing data to passengers. In some implementations, the server 122 may communicate with other systems, for example, the ground server 114, the database 116, and the gate terminal (not shown), which are located outside of the airplane 102. The server 122 can communicate with the systems on ground such as the ground server 114, the database 116, and the gate terminal via the antenna 124 for receiving and transmitting information from/to the other systems. In the example of FIG. 1, one or more satellites 108, 109, 110, and 111 are configured to provide satellite networks and include GEO (Geostationary Equatorial Orbit) satellites and/LEO (Low Earth Orbit) satellites. As further discussed later in this patent document, in the implementations of the disclosed technology, the airplane 102 includes an overlay network system (not shown) designed to handle traffic over the various network connectivity paths (e.g., satellites 108, 109, 110, 111, a cellular network utilizing one or more onboard base station(s), Wi-Fi utilizing the wireless access point 120, etc.) so that the passengers in the airplane can be connected to wireless services through an optimal network connectivity path.

GEO satellites appear to be motionless in the sky, providing the satellite with a continuous view of a given area on the surface of the Earth. Such an orbit can only be obtained by placing the satellite directly above the Earth's equator (0° latitude), with a period equal to the Earth's rotational period. LEO satellites are placed in circular orbits at low altitudes of less than 2,000 km. A constellation of LEO satellites can provide continuous world-wide coverages, but this requires many satellites as each one is over a given region for a relatively small amount of time. Because of their relative lower distance to the Earth, latency, the delay caused by the distance a signal must travel, is far less than all other orbits. While the LEO satellite and the GEO satellite are described, those satellites are examples only and the satellite network can include other satellites without being limited to LEO satellite and the GEO satellite. The number of different types of satellites, which provides wireless connection services for the aircraft 102, can be varied as well.

In some examples, cell towers 118 communicate or interface with the antenna 124 of the airplane 102, such that ground systems such as the ground server 114, the database 116, and the gate terminal can transmit and receive data with the server 122 and other in-vehicle systems. In some implementations, Wi-Fi element 119 provides a wireless local area network (WLAN) to allow the server 122 to communicate with the ground systems. Thus, the cell tower 118 and the Wi-Fi element 119 may act as communication nodes between the antenna 124 of the airplane 102 and the ground systems such as the ground server 114, the databases 116, and the ground terminal. In some implementations, the server 122 implements a router for the wireless onboard networks and various functionality disclosed herein to provide video streaming services for passengers in the airplane 102. The gate terminal can be implemented as a computing device and operate to maximize efficiency and safety of passenger transfers and aircraft servicing. The ground server 114 and the gate terminal may be in communication with the database 116 and provide information from the database 116 to the server 122 and store information received from the server 122 in the database 116. Although FIG. 1 shows that the database 116 is provided separately from the ground server 114, the database 116 can be provided as a part of the ground server 114.

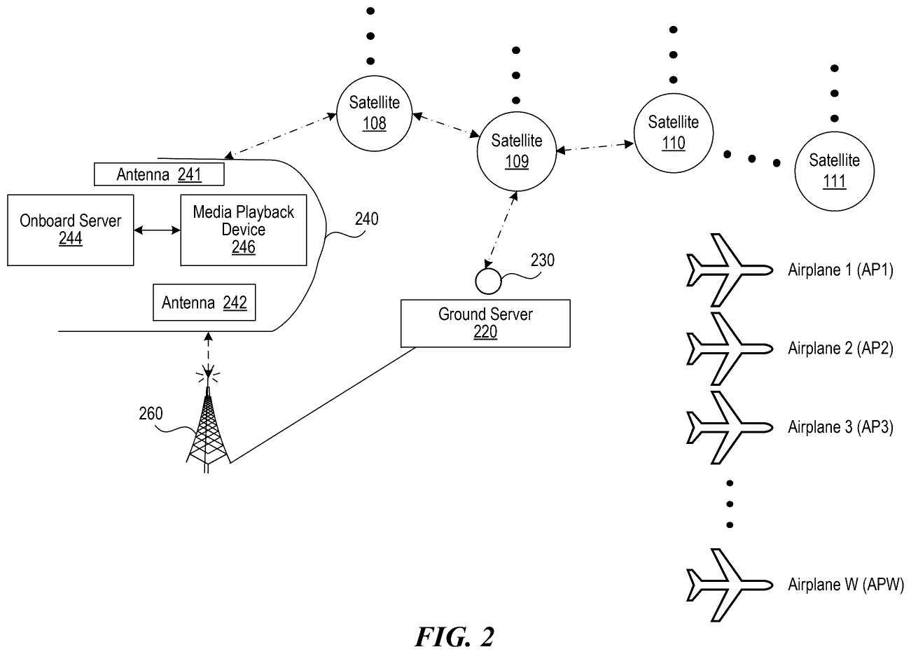

FIG. 2 shows an example of a configuration including an overlay network system based on some implementations of the disclosed technology. In the example system of FIG. 2, some elements of the aircraft 240 are shown, which include antennas 241 and 242, a media playback device 246, and an onboard server 244 in communication with the media playback device 246. The aircraft 240 is in communication with a ground server 220 through antennas 241 and 242 via one or more satellites 108, 109, 110, and 111 and/or a terrestrial communication station 260. The terrestrial communication station 260 is configured to provide cellular network for the aircraft 240. In the example, one or more satellites 108, 109, 110, and 111 are configured to provide satellite networks and include GEO (Geostationary Equatorial Orbit) satellites and/LEO (Low Earth Orbit) satellites.

The antennas 241 and 242 are configured to communicate with geostationary satellites and low earth orbit satellites to provide a satisfactory communication experience for passengers on the aircraft 240. In some implementations, a ground server antenna 230 can be provided to provide the connected network among the ground server 220, the aircraft 240, and the satellites 108, 109, 110, and 111. The ground server antenna 230 is an example only and other implementations are also possible. In some implementations, a wireless router such as an Internet modem can be configured to support the communication between the ground server 220 and the aircraft 240. In some implementations, a teleport can be configured to support the communication between the ground server 220 and the satellites 108, 109, 110, and 111.

In some implementations of the disclosed technology, the ground server 220, which in communication with the aircraft 240, the satellites 108, 109, 110, and 111, and the terrestrial communication station 260, is configured to control network connections for the aircraft 240. The ground server 220 can be configured to use a wide variety of resources including compute resources, storage resources, and other resources and control the network connections using various algorithms. The ground server 220 establishes the communication connections with the satellites 108, 109, 110, 111 via a teleport (not shown). The ground server 220 can receive real time data from the satellites 108, 109, 110, 111 and the terrestrial communication station 260. In addition, the multiple airplanes, Airplane 1 (AP1), Airplane 2 (AP2), Airplane 3 (AP3) . . . . Airplane W (APW), are illustrated in FIG. 2. Although some description above is provided for a single airplane in this document, those skilled in the art can understand that such description can be applied to the multiple airplanes. Thus, the ground server 220 can control the network connections for the multiple airplanes.

The ground server 220 can be configured in hardware, software, or any combination thereof. In some implementations, the ground server 220 can be configured in a cloud. In this case, the cloud platform for controlling the video streaming services exists with servers, processes, and databases, which are able to be connected connect over a wide area network, such as the Internet, from multiple computing devices and then the backend of the cloud platform is configured to control the network connection, by dynamically calling in additional computing hardware machines to load on and run the independent processes as needed.

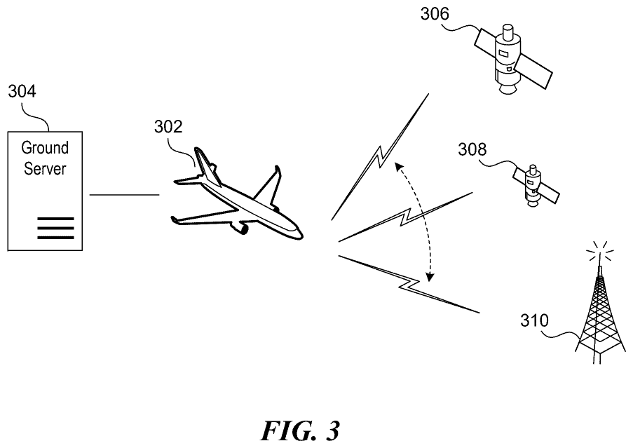

FIG. 3 shows an example of an overlay network system in communication with a commercial passenger vehicle. In the example of FIG. 3, the overlay network system may include a ground server 304 operable to control network connections for the commercial passenger vehicle. In the example, the overlay network system is in communication with an airplane 302 which is flying in the air. The airplane 302 is in communication with at least one of a GEO satellite 306, a LEO satellite 308, and the cellular network 310. In some implementations, the overlay network system includes a traffic shaping tool to shape network traffic over at least one of the networks provided by the GEO satellite 306, the LEO satellite 308, and the cellular network 310 to determine optimal network connectivity paths for electronic devices onboard the airplane 302. In some implementations, the airplane 302 is on ground and the overlay network system uses the traffic shaping tool to shape network traffic over at least one of the networks provided by the GEO satellite 306, the LEO satellite 308, the cellular network 310, and a ground Wi-Fi network (unpictured).

In implementations of the disclosed technology, the overlay network system uses secure vector routing (SVR) technology to manage network traffic over the various network connectivity paths for the airplane 302. In an example design, the overlay network system retrieves the IP information of a subscriber and shares the IP information with the traffic shaping tool such that the traffic shaping tool is aware of both the subscriber IP address and an underlay path associated with the network connectivity path of the subscriber. The underlay path may be, for example, a GEO underlay path, a LEO underlay path, a cellular underlay path, or a W-Fi underlay path corresponding to the networks provided by the GEO satellite 306, the LEO satellite 308, the cellular network 310, or the Wi-Fi network, respectively. In some implementations, the overlay network system will translate the source and destination IP addresses for all network packets trafficked between two networks so that the network packets will return to their original source and destination IP address once out of overlay network system.

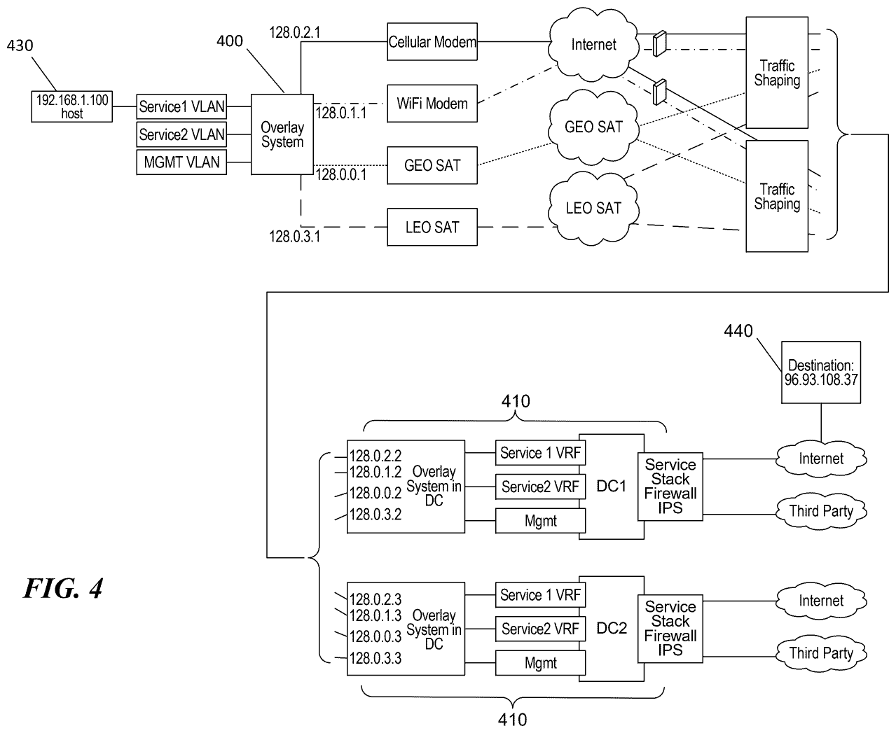

FIG. 4 shows an example configuration of an overlay network system with IP traffic shaping functionalities based on some implementations of the disclosed technology. The example diagram of the overlay network system as shown in FIG. 4 is provided to explain how traffic shaping with the overlay network system can be implemented in a commercial passenger vehicle such as the airplane 102. In the example of FIG. 4, the overlay system 400 is in communication with the overlay system hubs 410. The overlay system 400 includes various underlay network connectivity paths for the commercial passenger vehicle including the W-Fi connectivity path (dotted dashed line), the cellular network connectivity path (solid line), the GEO satellite network connectivity path (dotted line), and the LEO satellite network connectivity path (dashed line). In some implementations, the overlay system 400 also includes various WAN links (unpictured). The overlay system 400 may utilize secure vector routing technology to handle traffic over the various network connectivity paths as will be discussed in further details described in this patent document.

A remote unit 430, such as the airplane 102 or a device located onboard the airplane 102, is designated as a source host and is in communication with the overlay system 400. As shown in FIG. 4, the remote unit 430 is associated with a source IP address (e.g., 192.168.1.100) and configured to send traffic, such as a network packet, to a destination 440 associated with a destination IP address (e.g., 96.93.108.37). All IP addresses shown in FIG. 4 are used merely to facilitate understanding of the overlay network system and other numerical IP addresses are possible. When the traffic from the remote unit 430 that is to be sent to the destination 440 arrives at the overlay system 400, the overlay system 400, based on the best choice of WAN links, selects to pass the traffic using a particular network connectivity path (i.e., the W-Fi connectivity path (dotted dashed line), the cellular network connectivity path (solid line), the GEO satellite network connectivity path (dotted line), or the LEO satellite network connectivity path (dashed line)) to the overlay system hubs 410.

A significant challenge in existing overlay system technologies is that the mechanism behind overlay technology is to change the source and the destination IP addresses of the network packet being trafficked between two overlay systems. To overcome this challenge, the overlay network system of FIG. 4 includes a traffic shaping tool configured to monitor the underlay network link (i.e., the W-Fi connectivity path, the cellular network connectivity path, the GEO satellite network connectivity path, and the LEO satellite network connectivity path) to detect, in real-time, what traffic is using which WAN link such that original subscriber IP addresses are visible to the overlay network system.

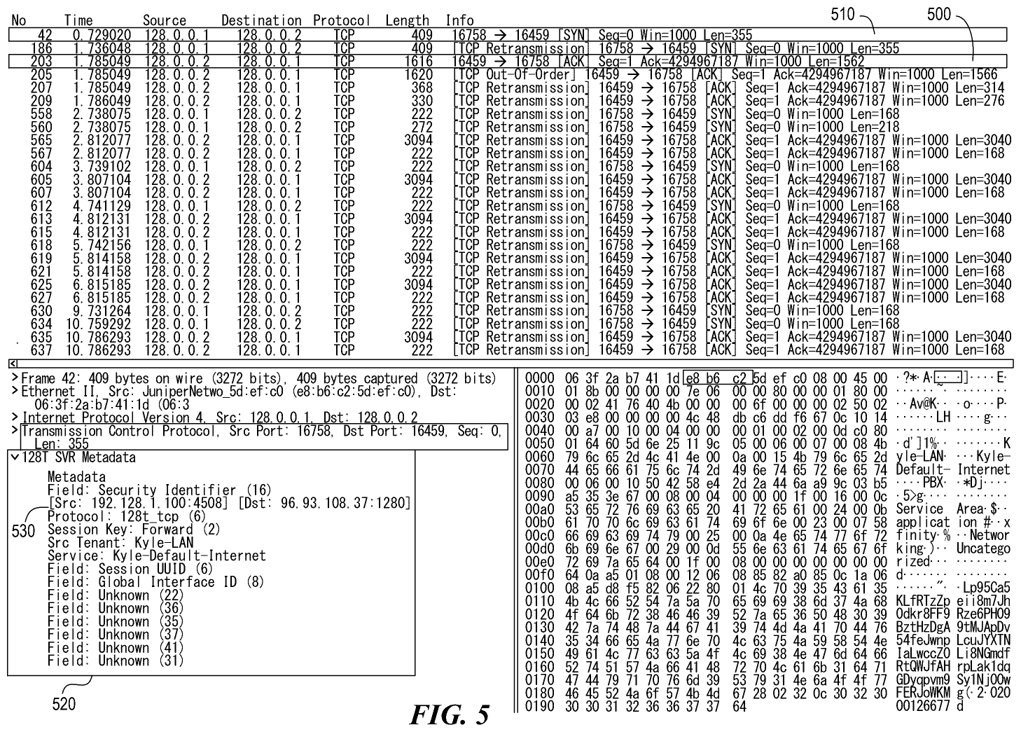

FIG. 5 shows an example of a screen showing packet analysis performed in an overlay network system based on some implementations of the disclosed technology. In some implementations, the traffic shaping tool tracks and records each network session (e.g., TDP session or UDP session) as shown in FIG. 5. When a new network session is detected by the traffic shaping tool, the traffic shaping tool will record the session and identify a first payload 500 of a first packet 510 of the session. For example, the traffic shaping tool can identify the first payload 500 in a first TCP syn packet of a TCP session as shown in FIG. 5. In some implementations, the traffic shaping tool collects SVR metadata 520 that is publicly available information. The traffic shaping tool is capable of reading, from the payload 500, the source IP address 530 of an original subscriber based on the SVR metadata 520. In some implementations, the traffic shaping tool is included in the overlay network system of FIG. 4 and may read the source IP address (192.168.1.100) associated with the remote unit 430 from a payload as described above. The traffic shaping tool can record the session and link the source IP address of the original subscriber (i.e., remote unit 430) to the session. In some implementations, the traffic shaping tool generates a user data report to bill a user associated with the report at a rate which is based on their use of a specific underlay network connectivity path.

In some implementations, the traffic shaping tool is configured to intercept the first metadata packet of a network session. Based on the metadata packet, the traffic shaping tool can determine various forms of information (e.g., source IP address, port number, etc.) and co-relate the information to an IP address and a Virtual Local Area Network (VLAN) associated with an underlay network path such as the W-Fi, cellular network, GEO satellite network, or LEO satellite network connectivity paths of FIG. 4. For example, the traffic shaping tool may use the IP address and the underlay VLAN to determine information related to airline, aircraft tail number, or user. The traffic shaping tool may apply various traffic shaping policies to network traffic, including policies based on user, aircraft tail number, airline, or underlay path. In some implementations, the traffic shaping policy includes the generation of a user data report containing information specific to the user, aircraft tail number, airline, or underlay path. In some implementations, an overlay network system based on the disclosed technology, implementing the traffic shaping tool, can translate an IP header associated with an original data packet with an IP header associated with overlay traffic flow. For instance, translation information can be exchanged between endpoints in the overlay network system through metadata. In some implementations, the overlay network system can encrypt the metadata to make sure user data is secured from air to ground.

In one example implementation, a deep packet inspection using a third-party application (e.g., Sandvine) is performed in the overlay network system in order to configure traffic shaping policies. For example, the overlay network system, based on the deep packet inspection, can determine traffic shaping policies which are based on passenger information, passenger device information, or the type of application being accessed by a passenger device. In some implementations, the third-party application is capable of viewing data translated in the overlay network system and performing a search of the metadata (e.g., searching the first few packets of traffic flow). As such, the third-party application can view the IP address of a device associated with a particular traffic flow. Information shared between the overlay network system and the third-party application can be used to determine traffic shaping policies or generate user data reports. In some implementations, per user traffic shaping policies are based on VLAN information of the underlay network connectivity paths shown in FIG. 4 which are seen by the third-party application.

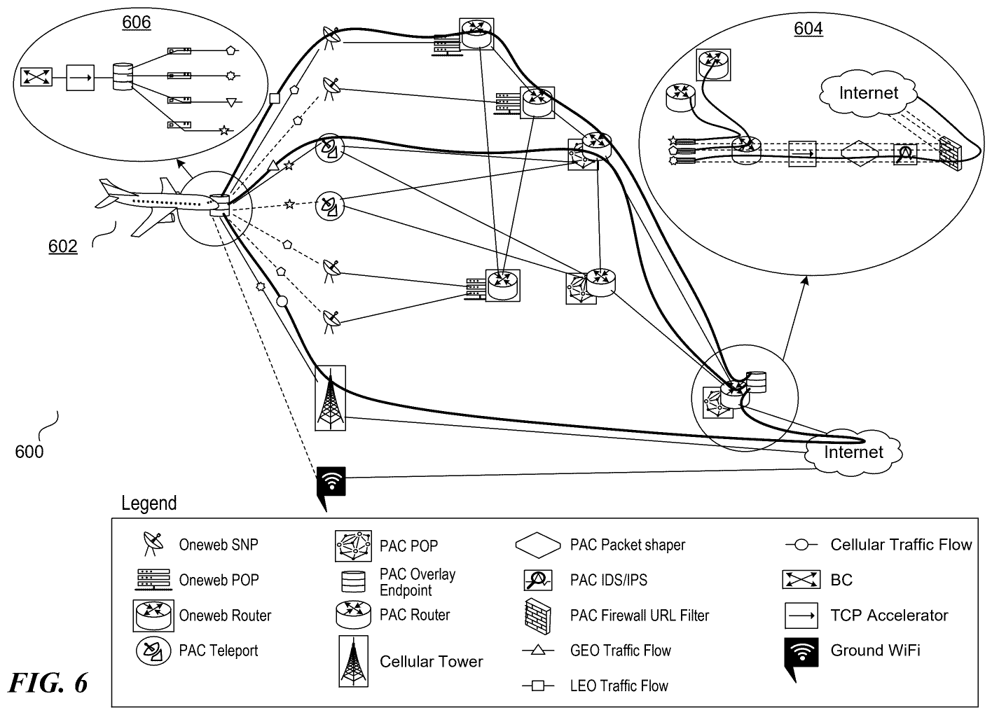

FIG. 6 shows an example air-to-ground network configuration including an overlay network platform 600 in communication with a commercial passenger vehicle such as the airplane 602 based on some implementations of the disclosed technology. In the example of FIG. 6, there are four underlay network paths that can be used to carry overlay traffic from passenger devices: a LEO underlay path, a GEO underlay path, a cellular data communication path when the airplane is on the ground, and a ground Wi-Fi data communication path when the airplane 602 is on the ground. In this example, both the cellular data communication path and the ground Wi-Fi data communication path will be referred as “ground path.”

The overlay network platform 600 is in communication with a groundside system 604. The ground side system 604 includes an operation support system (OSS) which signals the overlay network platform 600, via an overlay controller (unpictured) located on the ground, which underlay path should be used by the airplane 602. In some implementations, the overlay network platform 600 is configured to default to a default underlay path choice when the overlay network platform 600 cannot communicate with the overlay controller or the OSS. The default underlay path choice is based, in some implementations, on service-level agreement (SLA) monitoring results of the four underlay network paths. When multiple underlay network paths are available, the underlay path choice may be based on costs associated with the underlay path choice (e.g., ground path may be the first choice, then the LEO underlay path, then the GEO underlay path). Other loadshare mechanisms to support multiple paths simultaneously in the overlay network platform 600 are also possible.

In some implementations, the air-to-ground network configuration includes a TCP accelerator in communication with a broadband controller and the overlay network platform 600. In certain implementations, the TCP accelerator is integrated with the overlay network platform 600. In some implementations, the TCP accelerator includes a TCP acceleration service that can be optionally disabled on a per airline tail number basis. On the ground, the TCP accelerator may be deployed in the ground side system 604 in various configurations such as after an overlay endpoint of the overlay network platform 600 or between the packet shaper and the firewall which are included in the ground side system 604.

In some implementations, the air-to-ground network configuration supports the cellular data communication path and the ground Wi-Fi data communication path using IPv6. In some implementations, all devices and links in the ground network along the path between upstream internet service providers (ISPs) to the overlay platform are configured to run IPv4/IPv6 dual stack.

In some implementations, the overlay network platform 600 can apply different traffic shaping policies based on various criteria such as underlay path or underlay path usage rate. In order to apply different traffic shaping rate policies to different types of underlay paths, as well as differentiate different underlay usage, a set of overlay endpoints may be deployed at each point of presence (POP) in the air-to-ground network configuration. In the example of FIG. 6, the configuration includes multiple sets of overlay endpoints as indicated by the legend. The multiple sets of overlay endpoints can include, for example, a set of overlay endpoints that terminate GEO traffic, a set of overlay endpoints that terminate LEO traffic, and a set of overlay endpoints that terminate cellular or ground Wi-Fi traffic from the Internet. In some implementations, each set of overlay endpoints may decapsulate the network traffic of the associated underlay path and put the overlay traffic in a dedicated VLAN. For example, the GEO traffic may be assigned to VLAN with identification “X”, LEO traffic may be assigned to VLAN with identification “Y”, and the cellular or ground Wi-Fi traffic may be assigned to VLAN with identification “Z”. In some implementations, the overlay traffic is put in a dedicated VLAN based on IP address, aircraft tail number, or airline. The overlay network platform 600 is also capable of shaping traffic based on VLAN number in order to set different network usage rate policies. In some implementations, underlay usage along the different underlay paths is recorded such that passengers onboard the airplane 602 accessing the different underlay paths may be billed at different rates based on their usage of a particular underlay path. In some implementations, when a user device (unpictured) in the air-to-ground network configuration switches from one of the four underlay network paths (i.e., GEO underlay path, LEO underlay path, or ground path), user traffic flow may be reset.

In some implementations, the overlay network platform 600, via the airside system 606, may connect to the ground side system 604 through any of the underlay networks paths which are available. In some implementations, the overlay network platform 600 is configured to build connections to one or more groundside overlay platforms such as the groundside system 604. In one implementation, the overlay network platform 600 can build multiple service profiles for the airplane 602. For example, the airplane 602 may have a PED Internet egress allocated in Hong Kong, a phone service deployed in London, and an aircraft management center primary from Los Angles and secondary from New York City. In this example, the overlay network platform 600 is configured to build the following five service profiles for the airplane 602: (i) a first service profile may be provided for PED traffic and the underlay communication may terminate at a Hong Kong ground GEO overlay endpoint; (ii) a second service profile may be provided for PED traffic and the underlay communication may terminate at a Hong Kong ground LEO overlay endpoint; (iii) a third service profile may be provided for PED traffic and the underlay communication may terminate a Hong Kong ground cellular or ground Wi-Fi overlay endpoint; (iv) a fourth service profile may be provided for phone traffic and the underlay communication may terminate at a London ground overlay platform to achieve optimized routing of phone traffic; and (v) a fifth service profile may be provided for management traffic and the underlay communication may terminate at a Los Angeles ground overlay platform as primary and a New York City ground overlay platform as backup when the Los Angeles ground overlay platform is unavailable. In this example, the first service profile, the second service profile, and the third service profile provide optimized end to end routing of network traffic.

In some implementations, the air-to-ground network configuration 600 includes a flat routing network, such as the Oneweb network, for each of the underlay network paths. Among other features and benefits, the flat routing network may simplify performance of one or more of the TCP accelerators in the air-to-ground network configuration, simplify the network configuration of the GEO underlay path, and eliminate multi-tenancy requirements of the underlay paths. In the air-to-ground network configuration of FIG. 6, the Oneweb network is configured to exchange overlay platform endpoints and routing information between the Oneweb network and a ground network (e.g., the ground Wi-Fi or the cellular tower).

In some implementations, the overlay network platform 600 uses a VLAN and virtual routing and forwarding (VRF) to support communications with a GEO satellite network providing the GEO underlay path. In some implementations, some or all of the overlay endpoints supporting the GEO satellite network are put into the same routing table. In some implementations, the air-to-ground network configuration includes teleports that can be configured to support communications between the groundside system 604 and one or more satellites (e.g., satellites 108, 109, 110, and 111) configured to provide satellite networks.

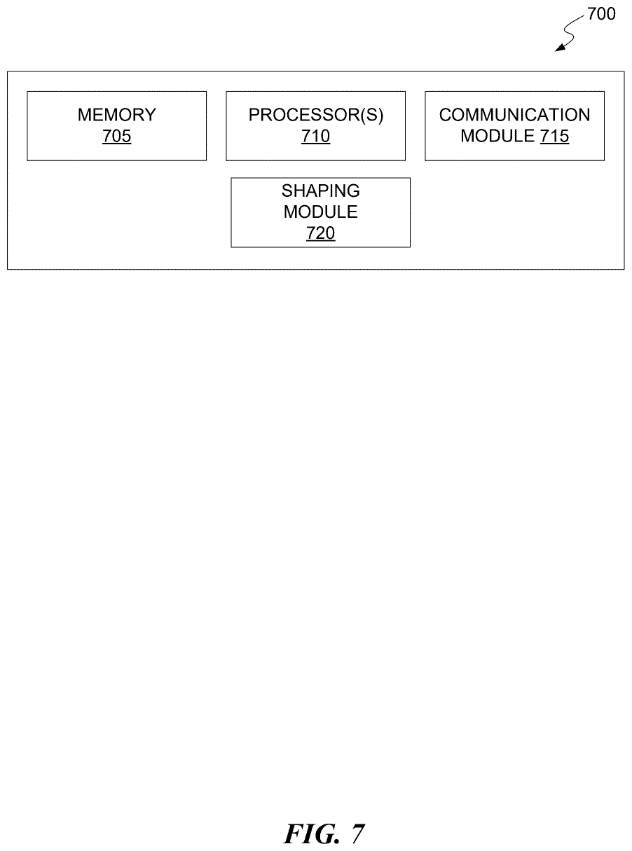

FIG. 7 shows an example of a block diagram of an overlay network system based on some implementations of the disclosed technology. The block diagram as shown in FIG. 7 can be applied to the ground server 304 as shown in FIG. 3. Referring to FIG. 7, the overlay network system 700 includes a memory 705, a processor 710, a communication module 715, and a shaping module 720. In other embodiments, additional, fewer, and/or different elements may be used to configure the overlay network system. While FIG. 7 shows the processor 710 and the shaping module 720 as separate elements, in some implementations, the processor 710 and the shaping module 720 can be implemented as one element. In this case, the shaping module 720 can be configured as a part of the processor 710.

In the implementations, the shaping module 720 is configured to employ per subscriber traffic shaping policies to control network traffic flow in the overlay network system. The shaping module 720 is aware not only of per subscriber traffic information (such as a subscriber's original source IP address) but also the underlay network path type (e.g., LEO satellite, GEO satellite, cellular) and real-time underlay network path usage. The traffic shaping module 720 employs various traffic shaping policies to shape different underlay paths of the same network traffic flow based, for example, on underlay network path type or underlay network path usage.

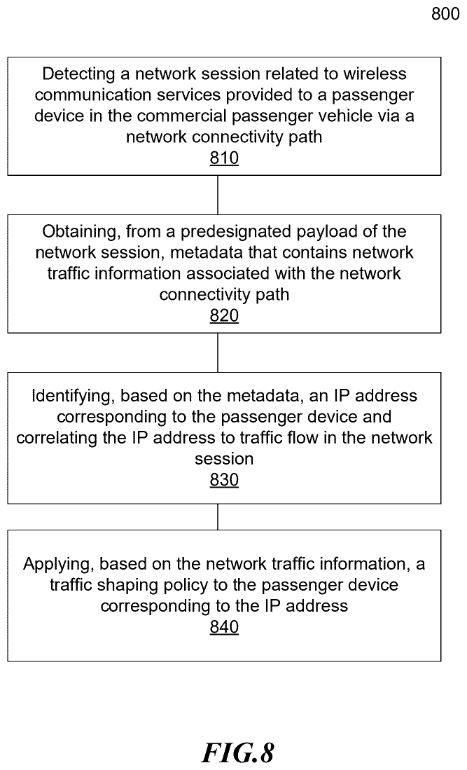

The memory 705 is an electronic holding place or storage for information or instructions so that the information or instructions can be accessed by the other elements of the overlay network system 700. The memory 705 can include, but is not limited to, any type of random access memory (RAM), any type of read only memory (ROM), any type of flash memory, etc. Such as magnetic storage devices (e.g., hard disk, floppy disk, magnetic strips, etc.), optical disks (e.g., compact disk (CD), digital versatile discs (DVD), etc.), smart cards, flash memory devices, etc. The instructions upon execution by the processor 710 configure the overlay network system to perform the operations (e.g., the operations, for example, as shown in FIG. 8) which will be described in this patent document. The instructions executed by the processor 710 may be carried out by a special purpose computer, logic circuits, or hardware circuits.

The processor 710 may be implemented in hardware, firmware, software, or any combination thereof. The term “execution” is, for example, the process of running an application or the carrying out of the operation called for by an instruction. The instructions may be written using one or more programming language, scripting language, assembly language, etc. By executing the instruction, the processor 710 can perform the operations called for by that instruction. The processor 710 operably couples with the memory 705, the communication module 715, and the shaping module 720 to receive, to send, and to process information and to control the operations of the ground server 304. The processor 710 may retrieve a set of instructions from a permanent memory device such as a ROM device and copy the instructions in an executable form to a temporary memory device that is generally some form of RAM. In some implementations, the ground server 304 can include a plurality of processors that use the same or a different processing technology.

The overlay network system further includes the communication module 715 to communicate with the airplanes to receive information related to the airplanes and provide the information to a selected network. The communication module 715 further allows the overlay network system to communicate with a hybrid network system including multiple satellite networks and the cellular network. While the communication module 715 is implemented as a single element, the communication module can be implemented as two separate elements, e.g., a transmitter and a receiver. In some implementations, the communication module 715 may be in communication with various servers/platforms that operate as sources of various data that is related to a travel by a commercial passenger vehicle.

FIG. 8 shows a block diagram of an example method 800 which may be implemented in an overlay network system based on some implementations of the disclosed technology. The method 800 includes, at step 810, detecting a network session related to wireless communication services provided to a passenger device in the commercial passenger vehicle via a network connectivity path. The method includes, at step 820, obtaining, from a predesignated payload of the network session, metadata that contains network traffic information associated with the network connectivity path. The method includes, at step 830, identifying, based on the metadata, an IP address corresponding to the passenger device and correlating the IP address to traffic flow in the network session. The method includes, at step 840, applying, based on the network traffic information, a traffic shaping policy to the passenger device corresponding to the IP address.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware, or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements and variations can be made based on what is described and illustrated in this patent document.

What is claimed is:

1. A method for managing network traffic flow for a commercial passenger vehicle, comprising:
receiving, by a server comprising at least one processor, a request for a network session from a passenger device operating in a communication network onboard a commercial passenger vehicle;
obtaining, from a payload of a predesignated packet in the network session, metadata that contains network traffic information associated with the communication network;
correlating an identifier for the passenger device to a traffic flow in the network session, wherein the identifier is based on the metadata; and
applying, based on the network traffic information, a traffic shaping policy to the passenger device corresponding to the identifier, wherein the traffic shaping policy controls routing of traffic flow of the passenger device through the communication network.

2. The method of claim 1, wherein the predesignated packet is a first packet in the network session, wherein the payload is a first payload of the first packet.

3. The method of claim 1, wherein the applying the traffic shaping policy comprises:
obtaining a usage rate of the communication network by the passenger device or a cost associated with the communication network; and
determining the traffic shaping policy based on the usage rate or the cost.

4. The method of claim 1, wherein the communication network is provided by a satellite network, a cellular network, or a ground Wi-Fi network, wherein the satellite network includes at least one of a Geostationary Earth (GEO) satellite or a Low Earth Orbit (LEO) satellite.

5. The method of claim 1, wherein the communication network includes an overlay network system configured to receive the network traffic flow using a plurality of WAN links,
wherein the method further comprises:
selecting, by the overlay network system, at least one of the plurality of WAN links over which to pass the network traffic flow based on real-time network path usage data.

6. The method of claim 5, wherein the traffic shaping policy is determined based on results of a deep packet inspection performed in the overlay network system.

7. The method of claim 1, wherein in response to the passenger device generating network traffic via a different communication network, the traffic shaping policy is modified.

8. The method of claim 1, wherein the traffic shaping policy includes generating a user data report, wherein a passenger associated with the passenger device is billed for network usage based on network usage rate information contained in the user data report.

9. The method of claim 1, wherein the network session is a TCP session, wherein the predesignated packet is a first SYN packet in the TCP session.

10. The method of claim 1, wherein the identifier is an IP address associated with the passenger device.

11. A system for managing network traffic flow for a commercial passenger vehicle, comprising:
a communication network, onboard the commercial passenger vehicle, comprising a plurality of network devices including passenger devices that are associated with respective passengers onboard the commercial passenger vehicle; and
a processor in communication with the communication network and operable to control network connections of the network devices to one or more satellites or terrestrial communication stations; and
wherein the processor is configured to:
receive, by a server comprising at least one processor, a request for a network session from at least one of the passenger devices operating in the communication network;
obtain, from a payload of a predesignated packet in the network session, metadata that contains network traffic information associated with the communication network;
correlate an identifier for the at least one of the passenger devices to a traffic flow in the network session, wherein the identifier is based on the metadata; and
apply, based on the network traffic information, a traffic shaping policy to the at least one of the passenger devices corresponding to the identifier, wherein the traffic shaping policy controls routing of traffic flow of the at least one of the passenger devices through the communication network.

12. The system of claim 11, wherein the predesignated packet is a first packet in the network session, wherein the payload is a first payload of the first packet.

13. The system of claim 11, wherein the processor is further configured to:
obtain a usage rate of the communication network by the passenger device or a cost associated with the communication network; and
determine the traffic shaping policy based on the usage rate or the cost.

14. The system of claim 11, wherein the communication network is provided by a satellite network, a cellular network, or a ground Wi-Fi network, wherein the satellite network includes at least one of a Geostationary Earth (GEO) satellite or a Low Earth Orbit (LEO) satellite.

15. The system of claim 11, wherein the communication network includes an overlay network system configured to receive the network traffic flow using a plurality of WAN links,
wherein the processor is further configured to:
select, by the overlay network system, at least one of the plurality of WAN links over which to pass the network traffic flow based on real-time network path usage data.

16. The system of claim 15, wherein the traffic shaping policy is determined based on results of a deep packet inspection performed in the overlay network system.

17. The system of claim 11, wherein in response to the at least one of the passenger devices generating network traffic via a different communication network, the traffic shaping policy is modified.

18. The system of claim 11, wherein the traffic shaping policy includes generating a user data report, wherein a passenger associated with the at least one of the passenger devices is billed for network usage based on network usage rate information contained in the user data report.

19. The system of claim 11, wherein the network session is a TCP session, wherein the predesignated packet is a first SYN packet in the TCP session.

20. The system of claim 11, wherein the identifier is an IP address associated with the passenger device.
